(19) United States
(12) Patent Application Publication
(10) Pub. No.: US 2022/0292396 A1
(43) Pub. Date: Sep. 15, 2022

(54) METHOD AND SYSTEM FOR GENERATING TRAINING DATA FOR A MACHINE-LEARNING ALGORITHM

(71) Applicant: YANDEX EUROPE AG, Luzern (CH)

(72) Inventors: Valentin Andreevich BIRYUKOV, Orenburg (RU); Nikita Vitalevich PAVLICHENKO, Moscow (RU); Valentina Pavlovna FEDOROVA, Sergiev Posad (RU)

(21) Appl. No.: 17/576,301

(22) Filed: Jan. 14, 2022

(30) Foreign Application Priority Data
Mar. 15, 2021 (RU) 2021106657

(51) Int. Cl. G06N 20/00; G06N 7/00

(52) U.S. Cl. CPC G06N 20/00; G06N 7/005

(57) ABSTRACT

A method and a system for generating training data for an MLA are provided. The method comprises: retrieving assessor data associated with a plurality of assessors, the assessor data including data indicative of a plurality of results responsive to a given digital task having been submitted to the plurality of assessors; based on the plurality of results, determining at least one set of assessors in the plurality of assessors, such that a consistency metric amongst results provided by the at least one set of assessors for the given digital task is maximized, transmitting a subsequent digital task to respective electronic devices associated with the at least one set of assessors; and generating the training data for the computer-executable MLA including data generated in response to respective ones of the at least one set of assessors completing the subsequent digital task.

### CROSS-REFERENCE

The present application claims priority to Russian Patent Application No. 2021106657, entitled “Method and System for Generating Training Data for a Machine-Learning Algorithm”, filed Mar. 15, 2021, the entirety of which is incorporated herein by reference.

### FIELD

The present technology relates to methods and systems for generating training data for a machine-learning algorithm (MLA); and more particularly, to methods and systems for identifying sets of assessors for executing tasks for the generating the training data.

### BACKGROUND

Machine-learning algorithms (MLAs) require a large amount of labelled data for training. Crowdsourcing platforms, such as an Amazon Mechanical Turk™ crowdsourcing platform, allow obtaining labelled training data sets by assigning various digital tasks to assessors provided with instructions to complete the digital tasks. By doing so, the crowdsourcing platforms may allow obtaining the labelled training data sets in a shorter time as well as at a lower cost compared to that needed for the use of a limited number of experts.

However, it is known that the assessors, unlike the experts, are generally non-professional and vary in levels of expertise, and therefore the obtained labels are much noisier than those obtained from experts.

There are several known sources of noise in a crowd-sourced environment. For example, a most studied kind of noise appears in multi-classification tasks, where assessors can confuse classes. Another type of noise is the automated bots, or spammers, that execute as many tasks as possible to increase revenue, which may decrease the overall quality of a resulting training data set.

One of approaches to assessing quality of the assessors executing the tasks and thus controlling the level of noise in the resulting labelled training data set is based on control tasks (also referred to herein as “honey pots”), that is, certain proportion of the tasks with predetermined expected results. Thus, based on how a given assessor executes the control tasks, a respective quality score thereof may be determined for the given assessor. Further, based on the so determined quality scores of the assessors, the labels provided thereby may be adjusted—such as by assigning weights indicative of the respective quality scores of the assessors—which may allow reducing the level of noise in the resulting training data set.

However, such an approach may not be effective, as some of the assessors (also referred to herein as “fraudsters”) may learn to recognize the control tasks and may thus faithfully execute them, while executing other tasks with lesser dedication or accuracy. Further, generating and providing new control tasks to detect fraudulent labelling may result in the resulting labelled training data set significantly increasing in cost.

Certain prior art approaches have been proposed to tackle the above-identified technical problem of increasing the quality of training data for MLAs.

U.S. Patent Application Publication No.: 2012/265,573-A1 published on Oct. 18, 2012, assigned to CrowdFlower Inc, and entitled “Dynamic Optimization for Data Quality Control in Crowd Sourcing Tasks to Crowd Labor” discloses systems and methods of dynamic optimization for data quality control in crowd sourcing tasks to crowd labor. In one aspect, embodiments of the present disclosure include a method, which may be implemented on a system, for dynamically monitoring results received from workers for a task distributed for evaluation via a job distribution platform, incrementally assigning additional workers to the task using the results and continuously monitoring additional results to assign any additional workers if needed to meet a quality metric for the task.

The article “Enhancing Reliability Using Peer Consistency Evaluation in Human Computation” written by Shih Wen Huang and Wai Tat Fu, published in Proceedings of the ACM Conference on Computer Supported Cooperative Work, CSCW, discloses human computation systems using peer consistency evaluation. It has been shown that simply telling the workers that their answers will be used as future evaluation standards can significantly enhance the workers' performance. Results have important implication for methods that improve the reliability of human computation systems.

### SUMMARY

It is an object of the present technology to ameliorate at least one inconvenience present in the prior art.

Developers of the present technology have appreciated that the overall quality of the resulting training data set may be increased if assessors executing tasks for the generation thereof could be identified based not only on respective quality scores thereof determined based on the control tasks, but also on how results provided thereby to previous tasks were in accord with results provided by the majority.

Thus, the developers of the present technology have devised a consistency metric (also referred to herein as a “majority vote”) indicative of a posteriori probability that a majority of a plurality of assessors has provided a correct result when executing a given task. Thus, by maximizing the consistency metric, the methods and systems described herein may allow determining at least one set of assessors for executing a subsequent task where each assessor has an optimal respective quality score for executing the subsequent task correctly with a predetermined confidence level.

By so doing, non-limiting embodiments of the present technology may allow, on one hand, increasing the overall quality of the resulting training data set without having to provide more control tasks for verifying accuracy of the provided results; and, on the other hand—identifying and further banning assessors providing inconsistent results, such as those systematically providing fraudulent results. Thus, a higher quality of the resulting training data set and efficiency of generation thereof may be achieved.

More specifically, in accordance with a first broad aspect of the present technology, there is provided a computer-implemented method of generating training data for a computer-executable Machine-Learning Algorithm (MLA). The training data is based on digital tasks accessible by a plurality of assessors. The method is executable at a server. The server includes a processor communicatively couplable, over a communication network, to electronic devices associated with the plurality of assessors. The method comprising: retrieving, by the processor, assessor data associated with the plurality of assessors, the assessor data including data indicative of past performance of respective ones of the plurality of assessors completing a given digital task including data indicative of a plurality of results responsive to the given digital task having been submitted to the plurality of assessors; based on the plurality of results, determining at least one set of assessors in the plurality of assessors, such that a consistency metric amongst results provided by the at least one set of assessors for the given digital task is maximized, the consistency metric being indicative of a posteriori probability that a result provided by a majority of the plurality of assessors is a correct result to the given digital task; transmitting, by the processor, a subsequent digital task to respective electronic devices associated with the at least one set of assessors; and generating the training data for the computer-executable MLA including data generated in response to respective ones of the at least one set of assessors completing the subsequent digital task.

In some implementations of the method, the consistency metric is determined in accordance with an equation:

$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$

where z^{MV} is a result of the plurality of result provided by the majority of the at least one set of assessors,
   y_{wi} is a given one of the plurality of results provided by a respective one of the at least one set of assessors,

$${q}_{wi} = \frac{{s}_{wi}}{100} ,$$

is a weighted respective quality score of the respective one of the at least one set of assessors, and
δ is a binary function returning 1 if an argument thereof is true, else returning 0.

In some implementations of the method, a given one of the plurality of assessors has a predetermined quality score, and the determining the at least one set of assessors is executed such that a given one of the at least one set of assessors has a respective predetermined quality score within a predetermined quality score range.

In some implementations of the method, the determining the at least one set of assessors is executed for a type of the subsequent digital task, the type being one of a set of pre-determined types.

In some implementations of the method, the type of the subsequent task is associated with the predetermined quality score range.

In some implementations of the method, the respective predetermined quality score has been determined based on accuracy of the given one of the at least one set of assessors completing a control digital task.

In some implementations of the method, the determining the at least one set of assessors in the plurality of assessors is triggered by receipt, by the server, of the subsequent digital task.

In some implementations of the method, the method further comprises determining, at least other one set of assessors for transmitting, to respective electronic devices thereof, an other subsequent task, different form the subsequent task.

In some implementations of the method, the at least one set of assessors and the at least other one set of assessors at least partially overlap.

In some implementations of the method, the at least one set of assessors and the at least other one set of assessors are mutually exclusive.

In accordance with a second broad aspect of the present technology, there is provided a computer-executable method for determining quality of training data having been generated for training a computer-executable Machine-Learning Algorithm (MLA). The training data is based on digital tasks accessible by a plurality of assessors. The method is executable at a server including a processor. The method comprises: retrieving, by the processor, a given dataset of the training data, the given dataset including: a plurality of results responsive to a given digital task having been submitted to the plurality of assessors; based on the plurality of results, determining a consistency metric amongst the plurality of results, the consistency metric being indicative of a number of the plurality of assessors providing a same result for the given digital task; in response to the consistency metric being equal to or greater than a predetermined consistency threshold, using the given dataset for the training the computer-executable MLA; and in response to the consistency metric being lower than the predetermined consistency threshold, discarding the given dataset from the training data.

In some implementations of the method, the consistency metric is determined in accordance with an equation:

$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$

where z^{MV} is a result of the plurality of result provided by a majority of the plurality of assessors,
y_{wi} is a given one of the plurality of results provided by a respective one of the plurality of assessors,

$${q}_{wi} = \frac{{s}_{wi}}{100} ,$$

is a weighted respective quality score of the respective one of the plurality of assessors, and

δ is a binary function returning 1 if an argument thereof is true, else returning 0.

In accordance with a third broad aspect of the present technology, there is provided a system for generating training data for a computer-executable Machine-Learning Algorithm (MLA). The training data is based on digital tasks accessible by a plurality of assessors. The system including a server further including: a processor communicatively couplable, over a communication network, to electronic devices associated with the plurality of assessors and a non-transitory computer-readable medium storing instructions. The processor, upon executing the instructions, being configured to: retrieve assessor data associated with the plurality of assessors, the assessor data including data indicative of past performance of respective ones of the plurality of assessors completing a given digital task including data indicative of a plurality of results responsive to the given digital task having been submitted to the plurality of assessors; based on the plurality of results, determine at least one set of assessors in the plurality of assessors, such that a consistency metric amongst results provided by the at least one set of assessors for the given digital task is maximized, the consistency metric being indicative of a posteriori probability that a result provided by a majority of the plurality of assessors is a correct result to the given digital task; transmit a subsequent digital task to respective electronic devices associated with the at least one set of assessors; and generate the training data for the computer-executable MLA including data generated in response to respective ones of the at least one set of assessors completing the subsequent digital task.

In some implementations of the system, the processor is configured to determine the consistency metric in accordance with an equation:

$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$

where z^{MV} is a result of the plurality of result provided by the majority of the at least one set of assessors,
   y_{wi} is a given one of the plurality of results provided by a respective one of the at least one set of assessors,

$${q}_{wi} = \frac{{s}_{wi}}{100} ,$$

is a weighted respective quality score of the respective one of the at least one set of assessors, and
δ is a binary function returning 1 if an argument thereof is true, else returning 0.

In some implementations of the system, a given one of the plurality of assessors has a predetermined quality score, and the processor is configured to determine the at least one set of assessors such that a given one of the at least one set of assessors has a respective predetermined quality score within a predetermined quality score range.

In some implementations of the system, the processor is configured to determine the at least one set of assessors for a type of the subsequent digital task, the type being one of a set of pre-determined types.

In some implementations of the system, the type of the subsequent task is associated with the predetermined quality score range.

In some implementations of the system, the processor has been configured to determine the respective predetermined quality score based on accuracy of the given one of the at least one set of assessors completing a control digital task.

In some implementations of the system, the processor is configured to determine the at least one set of assessors in the plurality of assessors responsive to receiving of the subsequent digital task.

In some implementations of the system, the processor is further configured to determine, at least other one set of assessors for transmitting, to respective electronic devices thereof, an other subsequent task, different form the subsequent task, the at least one set of assessors and the at least other one set of assessors at least partially overlapping.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an example computer system for implementing certain non-limiting embodiments of systems and/or methods of the present technology;

FIG. 2 depicts a networked computing environment configurable for generating training data for training a machine-learning algorithm (MLA), in accordance with certain non-limiting embodiments of the present technology;

FIG. 3 depicts a schematic diagram of an interface of a crowdsourcing application run on a server present in the networked computing environment of FIG. 2 for executing an example digital task by one of assessors, in accordance with certain non-limiting embodiments of the present technology;

FIG. 4 depicts a schematic diagram of a process for identifying, by the server present in the networked computing environment of FIG. 2, at least one set of assessors within a plurality of assessors based on a consistency metric, in accordance with certain non-limiting embodiments of the present technology;

FIG. 5 depicts a schematic diagram of a process for determining, by the server present in the networked computing environment of FIG. 2, subsets of assessors within the at least one set of assessors of FIG. 4 based on associated respective quality scores thereof, in accordance with certain non-limiting embodiments of the present technology;

FIG. 6 depicts a flowchart of a method for generating, by the server present in the networked computing environment of FIG. 2, the training data for training an MLA, in accordance with certain non-limiting embodiments of the present technology; and

FIG. 7 depicts a flowchart of a method for determining, by the server present in the networked computing environment of FIG. 2, quality of training data for training the MLA in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

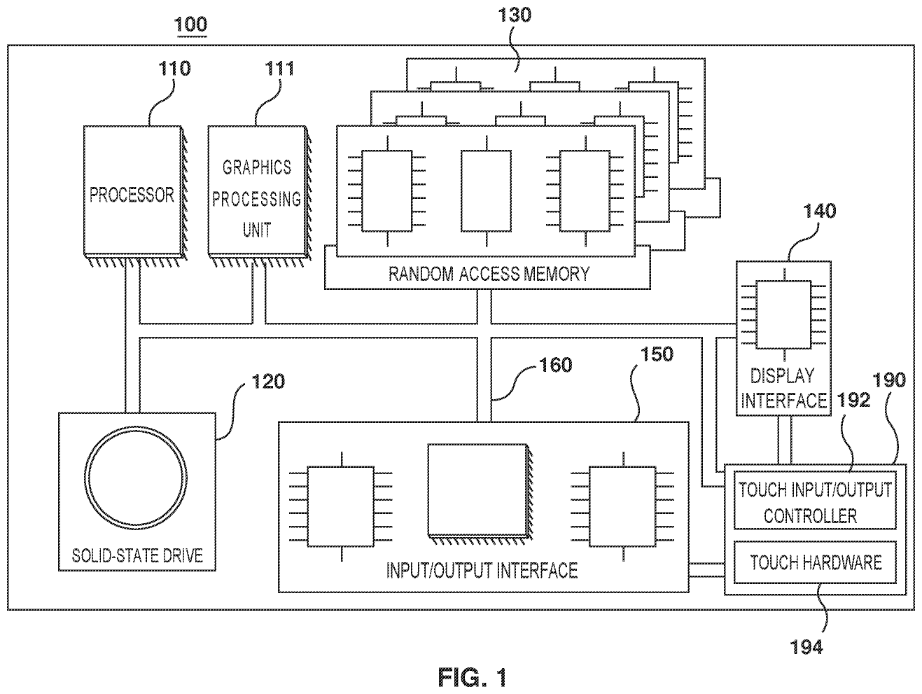

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some non-limiting embodiments of the present technology, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190.

It is noted that some components of the computer system 100 can be omitted in some non-limiting embodiments of the present technology. For example, the touchscreen 190 can be omitted, especially (but not limited to) where the computer system is implemented as a server.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

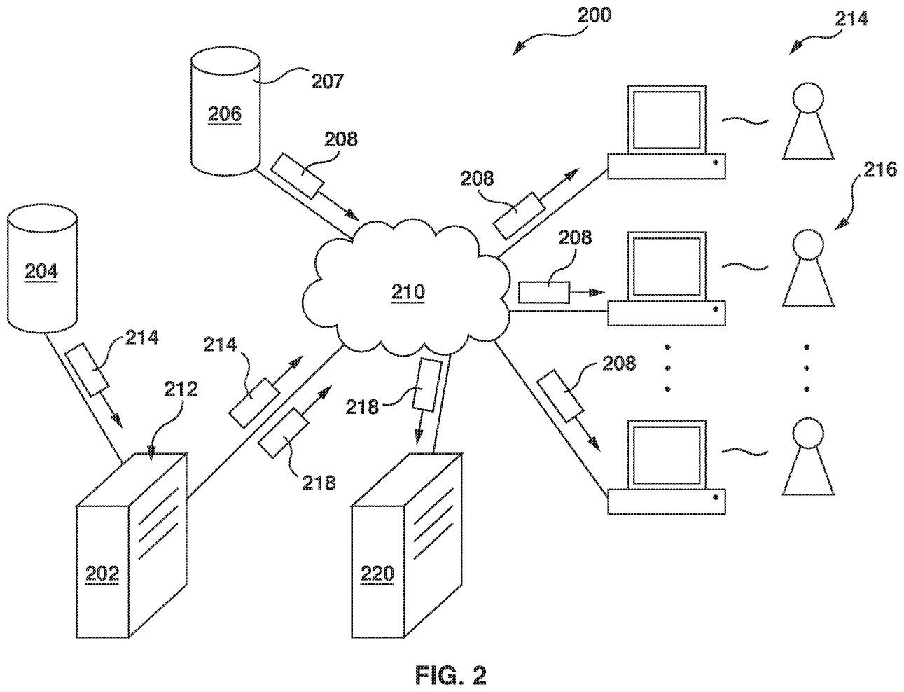

With reference to FIG. 2, there is depicted a schematic diagram of a networked computing environment 200 suitable for use with some non-limiting embodiments of the systems and/or methods of the present technology. The networked computing environment 200 comprises a server 202 and an assessor database 204 communicatively coupled with the server 202 over a respective communication link.

According to certain non-limiting embodiments of the present technology, the assessor database 204 may comprise an indication of identities of a plurality of assessors 214 (such as human assessors) available for completing at least one digital task (also referred to herein as a “human intelligence task (HIT)”, a crowd-sourced task, or simply, a task) and/or who have completed at least one digital task in the past and/or registered for completing at least one digital task. Further, in some non-limiting embodiments of the present technology, the assessor database 204 may also store assessor data associated with the plurality of assessors 214 including, for example, without limitation, sociodemographic parameters of each one of the plurality of assessors 214; data indicative of past performance of each one of the plurality of assessors 214; parameters indicative of accuracy of completing digital tasks associated with each one of the plurality of assessors 214—such as respective quality scores, as will be described in more detail below.

In some non-limiting embodiments of the present technology, the assessor database 204 can be under control and/or management of a provider of crowd-sourced services, such as Yandex LLC of Lev Tolstoy Street, No. 16, Moscow, 119021, Russia. In alternative non-limiting embodiments of the present technology, the assessor database 204 can be operated by a different entity.

The implementation of the assessor database 204 is not particularly limited and, as such, the assessor database 204 could be implemented using any suitable known technology, as long as the functionality described in this specification is provided for. Also, it should be noted that, in alternative non-limiting embodiments of the present technology, the assessor database 204 can be coupled to the server 202 over a communication network 210.

It is contemplated that the assessor database 204 can be stored at least in part at the server 202 and/or be managed at least in part by the server 202. In accordance with the non-limiting embodiments of the present technology, the assessor database 204 comprises sufficient information associated with the identity of at least some of the plurality of assessors 214 to allow an entity that has access to the assessor database 204, such as the server 202, to assign and transmit one or more tasks to be completed by the one or more assessors.

In some non-limiting embodiments of the present technology, the server 202 can be implemented as a conventional computer server and may thus comprise some or all of the components of the computer system 100 of FIG. 1. As a non-limiting example, the server 202 can be implemented as a Dell™ PowerEdge™ Server running the Microsoft™ Windows Server™ operating system. Needless to say, the server 202 can be implemented in any other suitable hardware and/or software and/or firmware or a combination thereof. In the depicted non-limiting embodiment of the present technology, the server 202 is a single server. In alternative non-limiting embodiments of the present technology, the functionality of the server 202 may be distributed and may be implemented via multiple servers.

In some non-limiting embodiments of the present technology, the server 202 can be operated by the same entity that operates the assessor database 204. In alternative non-limiting embodiments of the present technology, the server 202 can be operated by an entity different from the one that operates the assessor database 204.

In some non-limiting embodiments of the present technology, the server 202 may be configured to execute a crowdsourcing application 212. For example, the crowdsourcing application 212 may be implemented as a crowdsourcing platform such as Yandex.Toloka™ crowdsourcing platform, or other proprietary or commercially available crowdsourcing platform.

To that end, according to certain non-limiting embodiments of the present technology, the server 202 may be communicatively coupled, via the communication network 210, to a task database 206. In alternative non-limiting embodiments, the task database 206 may be coupled to the server 202 via a direct communication link. Although the task database 206 is illustrated schematically herein as a single entity, it is contemplated that the task database 206 may be implemented in a distributed manner.

The task database 206 is populated with digital tasks to be executed by at least some of the plurality of assessors 214. How the task database 206 is populated with the tasks is not limited. Generally speaking, one or more task requesters (not separately depicted) may submit one or more tasks to be stored in the task database 206. In some non-limiting embodiments of the present technology, the one or more task requesters may specify the type of assessors the task is destined to, and/or a budget to be allocated to each one of the plurality of assessors 214 providing a result.

For example, a given task requestor may have submitted, to the task database 206, a given digital task 208; and the server 202 may be configured to retrieve the given digital task 208 from the task database 206 and assign the given digital task to the plurality of assessors 214. Further, the server 202 may be configured to submit the given digital task 208 to the plurality of assessors 214 by transmitting an indication of the given digital task 208, via the communication network 210, to respective electronic devices (not separately labelled) of the plurality of assessors 214.

According to various non-limiting embodiments of the present technology, a respective electronic device associated with a given assessor 216 of the plurality of assessors 214 may be a device including hardware running appropriate software suitable for executing a relevant task at hand (such as the given digital task 208), including, without limitation, one of a personal computer, a laptop, an a smartphone, as an example. To that end, the respective electronic device may include some or all the components of the computer system 100 depicted in FIG. 1.

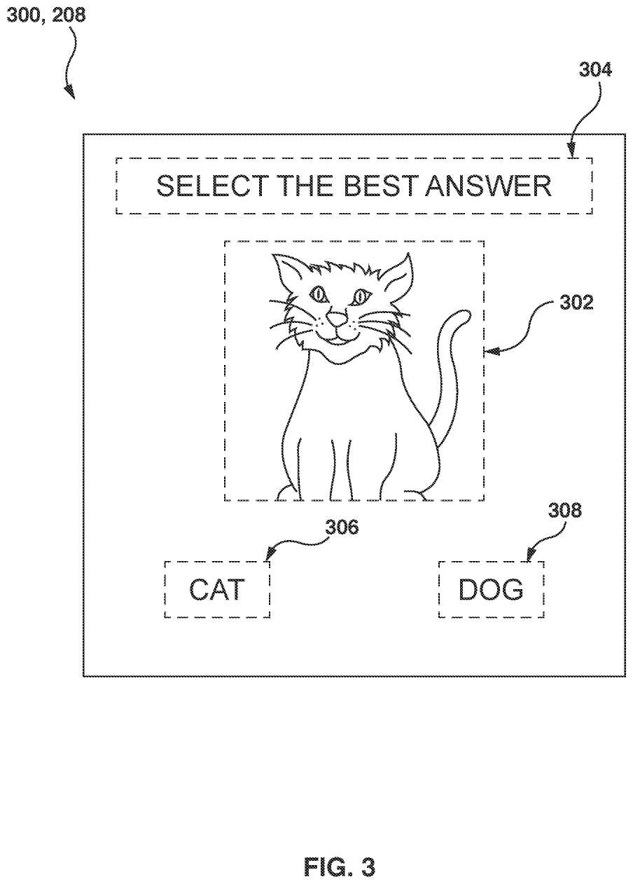

In some non-limiting embodiments of the present technology, the given digital task 208, stored in the task database 206, may be a classification task. As it can be appreciated, a classification task corresponds to a task in which a given one of the plurality of assessors 214 is provided with a piece of data to be classified according to a plurality of provided classification options. With reference to FIG. 3, there is schematically depicted a screen shot of a crowdsourcing interface 300 of the crowdsourcing application 212 for completion of an example classification task, in accordance with certain non-limiting embodiment, of the present technology. The crowdsourcing interface 300 is depicted in FIG. 3 as it may be displayed on a screen of one of the respective electronic devices of the plurality of assessors 214, as an example.

The crowdsourcing interface 300 illustrates an image 302 along with instructions 304 to the given assessor 216 of the plurality of assessors 214 to select one from at least two respective labels, best corresponding to the image 302: a first label 306 associated with one class (that is, “CAT”, for example) and a second label 308 associated with an other class (that is, “DOG”, for example). Thus, the given assessor 216, based on perception thereof, selects one of the first label 306 and the second label 308, thereby assigning a respective class to the image 302. It should be noted that other categories of classification tasks are contemplated, such as the classification of text documents, audio files, video files, and the like.

It should be noted that the given digital task 208, stored in the task database 206, can be of a type different that the classification task, for example, indicating a relevance parameter of a document to a search query (i.e. a regression task) and the like.

Also, although in the example of FIG. 3, the instructions 304 provide a binary choice—that is, selection out of the first label 306 and the second label 308, it should be expressly understood that other formats of the instructions 304 may be used, such as a scale of “1” to “5”, where “1” corresponds to one class, and “5” corresponds to the other class; or a scale of “1” to “10”, where “1” corresponds to the one class, and “10” corresponds to the other class, as an example. In other non-limiting embodiments of the present technology, the instructions 304 may provide a multiple-choice scale, where each value thereof is associated with a different class.

Referring back to FIG. 2, in some non-limiting embodiments of the present technology, the given digital task 208 may thus be submitted, by the given requester, to the task database 206, for example, for generating training data used for training a machine-learning algorithm (MLA) run by a third-party server 220 associated with the given task requestor. Needless to say, the third-party server 220 may be implemented in a fashion similar to the server 220, as described above. To that end, in some non-limiting embodiments of the present technology, the given digital task 208 may be one of a plurality of digital tasks 207 including, for example, hundreds, thousands, or even hundreds of thousands classification digital tasks similar to the given digital task 208, which the server 202 may be configured to submit for execution to generate a labelled training data set 218 for training the MLA run on the third-party server 220.

In some non-limiting embodiments of the present technology, the MLA may be based on neural networks (NN), convolutional neural networks (CNN), decision tree models, gradient boosted decision tree based MLA, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like. without departing from the scope of the present technology.

Further, the server 202 may be configured to transmit, over the communication network 210, the labelled training data set 218 to the third-party server 220. Thus, during a training phase, the third-party server 220 may be configured to train, based on the labelled training data set 218, the MLA to learn specific features, which may further be used, during an in-use phase, to classify input data, which may include, depending on the plurality of digital tasks, without limitation, images, audio files, video files, text documents, and the like.

In one example, where the third-party server 220 is a search engine server of a search engine application (such as a Yande™ search engine application, a Google™ search engine application, and the like), the so trained MLA may be used to execute classification tasks for providing search engine result pages (SERPs) better responsive to user requests. In another example, where the third-party server 220 is a server providing control to a self-driving car, the so trained MLA may be used to detect and recognize objects within scenes registered by sensors of the self-driving car. In yet other example, where the third-party server 220 is a server of a virtual assistant application (such as a Yande™ ALIS™ virtual assistant application, as an example), the so trained MLA may be used for recognizing user utterances within audio signals generated by a virtual assistant device executing the virtual assistant application. Other applications of the MLA trained based on the labelled training data set 218 as described above can also be envisioned without departing from the scope of the present technology.

Further, as it can be appreciated, overall quality of the labelled training set generally depends on how accurately each one of the plurality of assessors 214 completes each one of the plurality of digital tasks, and may thus depend on respective quality scores of each one of the plurality of assessors 214. Broadly speaking, a respective quality score associated with the given assessor 216 of the plurality of assessors 214, as used herein, may represent a measure of quality of results the given assessor 216 provides when completing digital tasks assigned thereto by the server 202. For example, the respective quality score may be indicative, directly or indirectly, of a level of experience and/or expertise of the given assessor 216. In other words, the respective quality score of the given assessor 216 can be said to be indicative of a likelihood value of the given assessor 216 completing the given digital task 208 correctly—such as selecting, using the respective electronic device, a correct one of the first label 306 over the second label 308 in the example of FIG. 3.

In some non-limiting embodiments of the present technology, the respective quality score of the given assessor 216 may have values from 0 to 1, where 0 is the lowest value, and 1 is the highest one. However, other scales and formats of representing values of the respective quality score of the given assessor 216 are also envisioned without departing from the scope of the present technology.

In this regard, in some non-limiting embodiments of the present technology, the given digital task 208 may be of one of predetermined types of digital tasks, where a given predetermined type is associated with a respective predetermined quality score range of assessors. For example, in some non-limiting embodiments of the present technology, the given predetermined type may be associated with digital tasks of various classification categories, such that a digital task for classification of human utterances may be associated with a higher predetermined quality score range than that for classification of images. However, in other non-limiting embodiments of the present technology, certain predetermined types of digital tasks may be defined within digital tasks of a given classification category—for example, based on complexity thereof. For example, the given predetermined type may be assigned to the given digital task 208 by the given task requester when submitting the given digital task to the task database 206.

In some non-limiting embodiments of the present technology, the server 202 may be configured to determine the respective quality score of the given assessor 216 based on control digital tasks with pre-associated correct results (so called “honey pots”) submitted to the given assessor 216 from time to time (or at a predetermined frequency) to assess accuracy of provided results.

However, in other non-limiting embodiments of the present technology, the server 202 may be configured to determine the respective quality score of the given assessor 216 using one of the approaches described in a co-owned Patent Application entitled “METHOD AND SYSTEM FOR GENERATING TRAINING DATA FOR A MACHINE-LEARNING ALGORITHM” bearing an Attorney Docket No.: 40703-215 (U.S. Patent Application No. not being available yet), which is filed concurrently herewith, content of which is incorporated herein by reference in its entirety. To that end, more specifically, the server 202 may be configured to: (1) retrieve assessor data associated with a past plurality of assessors, including the given assessor 216, the assessor data being indicative of past performance of respective ones of the past plurality of assessors completing a given digital task, the assessor data including: data indicative of a plurality of results responsive to the given past digital task having been submitted to the past plurality of assessors; and data indicative of respective quality scores of each one of the past plurality of assessors; (2) determine, for a given result of the plurality of results, a number of instances thereof within the plurality of results; (3) determine, based on the number of instances and respective quality scores of those of the past plurality of assessors having provided the given result, a respective value of an aggerate quality metric associated with the given result; identify a reliable result of the plurality of results as being associated with a maximum value of the aggregate quality metric; (4) determine, based on the reliable result, updated quality scores for each one of the past plurality of assessors, such that: in response to the given assessor 216 having provided a respective result corresponding to the reliable result, increase the respective quality score associated with the given assessor 216 by a predetermined value; and in response to the given assessor 216 having provided the respective result not corresponding to the reliable result, decrease the respective quality score by the predetermined value; (5) in response to a respective updated quality score associated with the given assessor 216 being greater than or equal to a predetermined quality score threshold, include the given assessor 216 in the plurality of assessors 214; (6) transmit the given digital task 208 to be completed to respective electronic devices associated with the plurality of assessors 214; and generate the training data (such as the labelled training data set 218) for the MLA including data generated in response to respective ones of the plurality of assessors 214 completing the given digital task 208.

However, some of the plurality of assessors 214 (also known as “fraudsters”) may learn to identify the control digital tasks and provide correct results thereto to maintain a relatively high respective quality score, while completing other tasks with less accuracy, providing thereto results of lower quality. This may induce noise to the labelled training data set 218 resulting in a lower quality thereof. The problem can further be exacerbated by the fact that, in such a case, identifying the fraudsters in a timely manner can be challenging as it may require developing new control tasks.

Further, certain non-limiting embodiments of the present technology have been developed based on developers' appreciation that even those of the plurality of assessors 214 having relatively high respective quality scores may provide different results to the given digital task 208.

Thus, certain non-limiting embodiments of the present technology are directed to determining, within the plurality of assessors 214, based on a plurality of results thereof responsive to the given digital task 208, at least one set of assessors such that discrepancy among results thereof is minimized. In other words, the methods and systems described herein are directed to maximizing a so-called consistency metric, associated with the plurality of assessors 214, which is indicative of a posteriori probability value that a majority of the plurality of assessors has provided a correct result, thereby identifying the at least one set of assessors likely to provide consistent results thereamong to subsequent digital tasks in future. Further, within the at least one set of assessors likely to provide consistent results, the server 202 may be configured to identify those associated with higher respective quality scores for assigning thereto subsequent digital tasks of an associated predetermined type (such as of higher complexity, as an example).

Thus, the present methods and systems may allow determining reliable results to digital tasks of the plurality of digital tasks 207 executed by respective sets of assessors. This may be achieved by considering both (1) results provided by majority of the respective sets of assessors executing the plurality of digital tasks 207, which can be represented by the consistency metric; and (2) respective quality scores associated therewith, which may further allow reducing use of control digital tasks for determining quality of provided results and effectively identifying and then dismissing fraudsters among assessors. This may hence enable to increase efficiency of generating the labelled training data set 218 and the overall quality thereof.

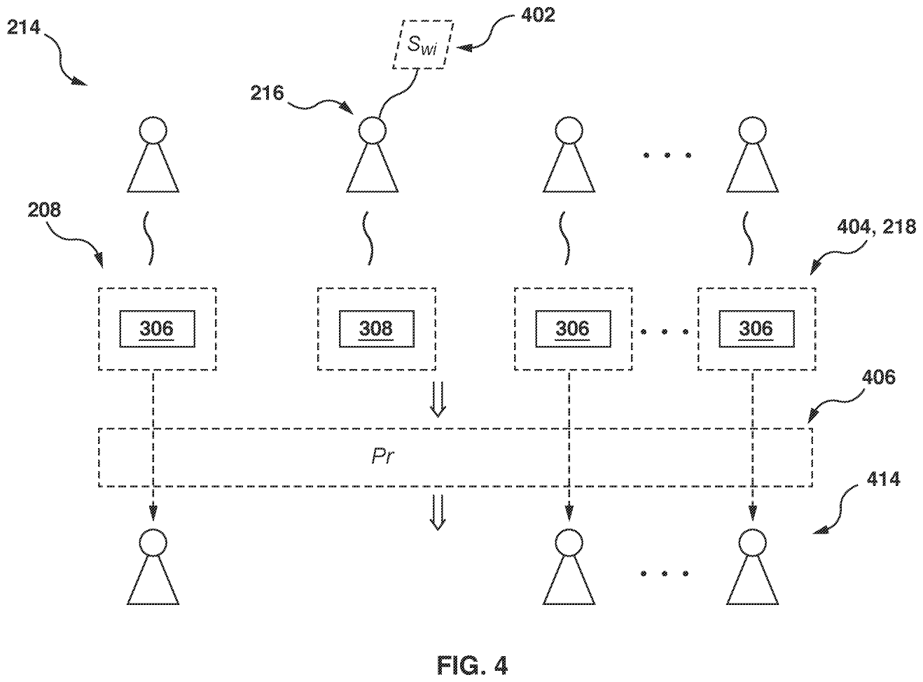

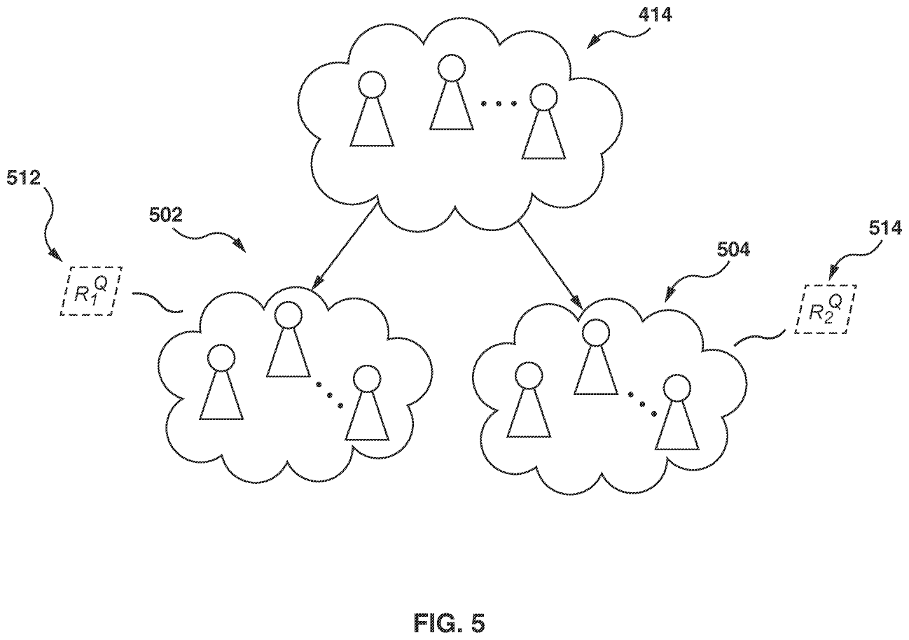

How the server 202 can be configured to determine the at least one set of assessors from the plurality of assessors 214 based on the consistency metric, in accordance with certain non-limiting embodiments of the present technology, will be described below with reference to FIGS. 4 to 5.

### Communication Network

In some non-limiting embodiments of the present technology, the communication network 210 is the Internet. In alternative non-limiting embodiments of the present technology, the communication network 210 can be implemented as any suitable local area network (LAN), wide area network (WAN), a private communication network or the like. It should be expressly understood that implementations for the communication network are for illustration purposes only. How a respective communication link (not separately numbered) between each one of the server 202, the assessor database 204, the task database 206, the third-party server 220, each one of electronic devices of the plurality of assessors 214, and the communication network 210 is implemented will depend, inter alia, on how each one of each one of the server 202, the assessor database 204, the task database 206, the third-party server 220, and the electronic devices associated with the plurality of assessors 214 is implemented. Merely as an example and not as a limitation, in those embodiments of the present technology where a given one of the electronic devices of the plurality of assessors 214 includes a wireless communication device, the communication link can be implemented as a wireless communication link. Examples of wireless communication links include, but are not limited to, a 3G communication network link, a 4G communication network link, and the like. The communication network 210 may also use a wireless connection with the server 202 and the task database 206.

### Determining Set(s) of Assessors

As noted hereinabove, in some non-limiting embodiments of the present technology, the server 202 may be configured to (1) receive, from the assessor database 204, indication of identities of the plurality of assessors 214 for completing the given digital task 208; (2) receive assessors data of past performance of each one of the plurality of assessors 214 including the respective quality scores associated therewith; (3) receive the plurality of results provided by the plurality of assessors 214 to the given digital task 208; (4) determine, based on the plurality of results, the consistency metric associated with the plurality of assessors 214; and (5) maximizing the consistency metric, determine at least one set of assessors for completing subsequent ones of the plurality of digital tasks 207.

With reference to FIG. 4, there is provided a schematic diagram of a process for determining, by the server 202, a set of assessors 414 from the plurality of assessors 214 based on the consistency metric associated therewith, in accordance with certain non-limiting embodiments of the present technology.

Thus, as best shown in FIG. 4, the server 202 may be configured to retrieve, from the assessor database 204, current values of the respective quality scores of the plurality of assessors 214, such as a current value 402 s_{wi} of the respective quality score of the given assessor 216. Further, as noted above, the server 202 may be configured to submit the given digital task 208 to the plurality of assessors 214 by transmitting, via the communication network 210, the indication of the given digital task 208 to respective electronic devices of the plurality of assessors 214. In some non-limiting embodiments of the present technology, the server 202 may have selected the given digital task 208 for completion thereof by the plurality of assessors 214 based on the current values of the respective quality scores of the plurality of assessors.

Further, the server 202 may be configured to receive a plurality of results 404 provided by the plurality of assessors 214 when executing the given digital task 208. As it can be appreciated from FIG. 4, each one of the plurality of results 404 includes an instance of one of the first label 306 and the second label 308 selected by a respective one of the plurality of assessors 214 when completing the given digital task 208. The server 202 may further be configured to include the plurality of results 404 in the labelled training data set 218.

Further, according to certain non-limiting embodiments of the present technology, the server 202 may be configured to determine, based on the plurality of results 404, a given value 406 of the consistency metric associated with the plurality of assessors 214. Broadly speaking, the consistency metric, as described herein, is indicative of a posteriori probability value that a majority of a given plurality of assessors, such as that of the plurality of assessors 214, has provided a correct result to the given digital task 208. In other words, if the plurality of assessors 214 has differed on the provided results, the consistency metric has a lower value. By contrast, if the majority of the plurality of assessors 214 has provided a same result, the consistency metric has a higher value.

In some non-limiting embodiments of the present technology, the server 202 may be configured to determine the given value 406 of the consistency metric in accordance with an equation:

$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} , \qquad ( 1 )$$

where z^{MV} is a result of the plurality of results 404 provided by the majority of the plurality of assessors 214,
y_{wi} is a given one of the plurality of results 404 provided by a respective one of the plurality of assessors 214—such as that provided by the given assessor 216,

$${q}_{wi} = \frac{{s}_{wi}}{100} ,$$

is a weighted value of the respective quality score of the given assessor 216, and

δ is a binary function returning 1 if an argument thereof is true, else returning 0.

Further, in some non-limiting embodiments of the present technology, the server 202 may be configured to determine the set of assessors 414 based on comparing the given value 406 of the consistency metric to a predetermined consistency threshold value. For example, the predetermined consistency threshold value may be prespecified by the given task requestor when submitting the given digital task 208 of the plurality of digital tasks 207 to the task database 206; and may be 0.7, 0.8, or 0.9, as an example.

Thus, in response to the given value 406 being greater than or equal to the predetermined consistency threshold value, the server 202 may be configured to determine the set of assessors 414 as being the plurality of assessors 214. In other words, if the given value 406 of the consistency metric is greater than or equal to the predetermined consistency threshold value, the plurality of assessors 214 may be considered as providing consistent results and may further be used for executing at least one subsequent digital task of the plurality of digital tasks 207.

However, in response to the given value 406 of the consistency metric being lower than the predetermined consistency threshold value, the server 202 may be configured to maximize the consistency metric associated with the plurality of assessors 214, thereby determining the set of assessors 414.

To that end, in some non-limiting embodiments of the present technology, the server 202 may be configured to exclude, from the plurality of assessors 214, at least one from those having provided inconsistent results. Continuing with the example of FIG. 4, assume that the majority of the plurality of assessors has provided the first label 306 when executing the given digital task 208; thus, the server 202 may be configured to exclude, from the plurality of assessors 214, the given assessor 216 as the respective one of the plurality of results 404 provided thereby, that is, the second label 308, is different from that provided by the majority of the plurality of assessors 214.

Further, after excluding the given assessor 216, the server 202 may be configured to determine if an updated value (not depicted) of the consistency metric is greater than or equal to the predetermined consistency threshold value; and if not, the server 202 may be configured to continue identifying and removing those of the plurality of assessors 214 that have provided inconsistent results when executing the given digital task 208.

Thus, in some non-limiting embodiments of the present technology, to determine the set of assessors 414 for executing the at least one subsequent digital task of the plurality of digital tasks 207, the server 202 may be configured to optimize the consistency metric by (1) iteratively identifying and removing those of the plurality of assessors 214 having provided results inconsistent with that provided by the majority; and (2) determining, at each iteration, a respective value of the consistency metric, until it meets the condition of being greater than or equal to the predetermined consistency threshold value. Thus, by excluding from the plurality of assessors 214 those assessors providing inconsistent results, in some non-limiting embodiments of the present technology, the server 202 may be configured to maximize the consistency metric to a value of greater than or equal to the predetermined consistency threshold value, thereby determining the set of assessors 414 likely to provide consistent results to the at least subsequent tasks of the plurality of digital tasks 207.

In additional non-limiting embodiments of the present technology, where the at least one subsequent digital task is of one of predetermined types of digital tasks, associated with a predetermined quality score range of assessors, the server 202 may further be configured to determine the set of assessors 414 such that their respective quality scores are within a predetermined quality range score. To that end, the server 202 may be configured to optimize the consistent metric identifying and removing not only those of the plurality of assessors 214 providing inconsistent results, but also those whose respective quality scores are lower than a lower boundary of the predetermined quality score range, as an example.

However, in other non-limiting embodiments of the present technology, first, the server 202 may be configured to optimize the consistency metric associated with the plurality of assessors 214 to determine the set of assessors 414, and then identify, within the set of assessors 414, one or more subsets of assessors associated with respective predetermined quality score ranges.

With reference to FIG. 5, there is depicted a schematic diagram of a process for identifying, by the server 202, at least two subsets of assessors within the set of assessors 414, in accordance with certain non-limiting embodiments of the present technology.

As it can be appreciated from FIG. 5, the server 202 can be configured to identify, within the set of assessors 414, at least two subsets of assessors, based on respective predetermined quality scores range, including (1) a first subset of assessors 502, each one of which having a respective quality score within a first predetermined quality score range 512, R^{Q}₁; and (2) a second subset of assessors 504, each one of which having a respective quality score within a second predetermined quality score range 514, R^{Q}₂.

In some non-limiting embodiments of the present technology, the server 202 may be configured to identify the at least two subsets of assessors within the set of assessors 414 for submitting thereto different subsequent digital tasks from the plurality of digital tasks 207. For example, the first predetermined quality score range 512 may be higher than the second predetermined quality score range 514; and thus the server 202 may be configured to submit subsequent digital tasks of higher complexity to the first subset of assessors 502 than to the second subset of assessors 504.

Further, although the first subset of assessors 502 and the second subset of assessors 504 are depicted in FIG. 5 as being mutually exclusive, that is, including different assessors of the set of assessors 414, it should be expressly understood that, in other non-limiting embodiments of the present technology, the first subset of assessors 502 and the second subset of assessors 504 can at least partially overlap. As an example, and not as a limitation, if the first predetermined quality score range 512 is from 0.6 to 0.8, and the second predetermined quality score range 514 is from 0.5 to 0.7, assessors of the set of assessors 414 having respective quality scores from 0.6 to 0.7 can be included in both the first subset of assessors 502 and the second subset of assessors 504.

Further, in some non-limiting embodiments of the present technology, the server 202 may be configured to generate a respective set of assessors, as described above with reference to FIGS. 4 and 5, for completion of each subsequent digital task of the plurality of digital tasks 207. However, in other non-limiting embodiments of the present technology, the server 202 may be configured to determine new sets of assessors for executing subsequent digital tasks of the plurality of digital tasks 207 from time to time, such as at a predetermined frequency, as an example.

Thus, according to certain non-limiting embodiments of the present technology, by submitting each one of the plurality of digital tasks 207 to respective so determined sets of assessors, the server 202 may be configured to aggregate respective pluralities of results—such as the plurality of results 404 responsive to submitting the given digital task 208 to the plurality of assessors 214, thereby generating the labelled training data set 218, which further may be used for training the MLA on the third-party server 220 as described above.

### First Method

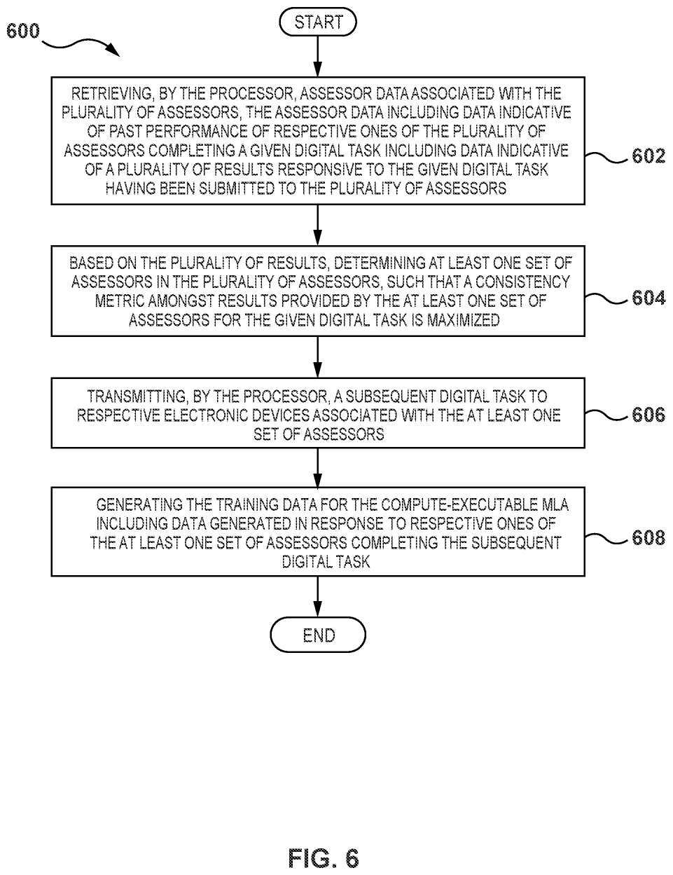

Given the architecture and the examples provided hereinabove, it is possible to execute a method for generating training data for training an MLA, such as the labelled training data set 218 described above, based on digital tasks executed by assessors. With reference to FIG. 6, there is depicted a flowchart of a first method 600, according to the non-limiting embodiments of the present technology. The first method 600 can be executed by the server 202 including the computer system 100.

STEP 602: RETRIEVING, BY THE PROCESSOR, ASSESSOR DATA ASSOCIATED WITH THE PLURALITY OF ASSESSORS, THE ASSESSOR DATA INCLUDING DATA INDICATIVE OF PAST PERFORMANCE OF RESPECTIVE ONES OF THE PLURALITY OF ASSESSORS COMPLETING A GIVEN DIGITAL TASK INCLUDING DATA INDICATIVE OF A PLURALITY OF RESULTS RESPONSIVE TO THE GIVEN DIGITAL TASK HAVING BEEN SUBMITTED TO THE PLURALITY OF ASSESSORS

The first method 600 commences at step 602 with the server 202 being configured to receive, from the task database 206, the indication of the given digital task 208 of the plurality of digital tasks 207 submitted to the task database 206 by the given task requestor. For example, as mentioned above, the given task requestor may have submitted the plurality of digital tasks 207 for generating the labelled training data set 218 for training the MLA run on the third-party server 220.

Thus, in some non-limiting embodiments of the present technology, the server 202 may be configured to retrieve, from the assessor database 204, the indication of identities of the plurality of assessors 214 for submitting the given digital task 208 thereto. Further, the server 202 may be configured to retrieve, from the assessor database 204, the assessor data of past performance of each one of the plurality of assessors 214. For example, assessor data of past performance of the plurality of assessors may include the respective quality scores associated with each one of the plurality of assessors 214—such as the current value 402 of the respective quality score associated with the given assessor 216, as described above with reference to FIG. 4.

As mentioned above, in some non-limiting embodiments of the present technology, the server 202 may be configured to determine the current value 402 of the respective quality score based on control digital tasks provided to the given assessor 216 from time to time in concert with the plurality of digital tasks 207.

However, as further described above, in other non-limiting embodiments of the present technology, the server 202 may be configured to determine the respective quality score of the given assessor 216 using one of the approaches described in the co-owned Patent Application entitled “METHOD AND SYSTEM FOR GENERATING TRAINING DATA FOR A MACHINE-LEARNING ALGORITHM” bearing an Attorney Docket No.: 40703-215 (U.S. Patent Application No. not being available yet), which is filed concurrently herewith, content of which is incorporated herein by reference in its entirety.

Further, the server 202 may be configured to submit the given digital task 208 to the plurality of assessors 214 for completion by transmitting the indication of the given digital task 208 to the respective electronic devices of the plurality of assessors 214 as depicted in FIG. 2. Further, as described above with reference to FIG. 4, the server 202 may be configured to receive, from the plurality of assessors 214, the plurality of results 404 responsive to the given digital task 208.

The first method 600 thus proceeds to step 604.

STEP 604: BASED ON THE PLURALITY OF RESULTS, DETERMINING AT LEAST ONE SET OF ASSESSORS IN THE PLURALITY OF ASSESSORS, SUCH THAT A CONSISTENCY METRIC AMONGST RESULTS PROVIDED BY THE AT LEAST ONE SET OF ASSESSORS FOR THE GIVEN DIGITAL TASK IS MAXIMIZED

Further, at step 604, according to certain non-limiting embodiments of the present technology, based on the plurality of results 404, the server 202 may be configured to determine a respective value of the consistency metric associated with the plurality of assessors 214—such as the given value 406, as described above with reference to FIG. 4.

As noted hereinabove, the consistency metric is indicative of the posteriori probability value that the majority of the plurality of assessors 214 has provided the correct result to the given digital task 208. In some non-limiting embodiments of the present technology, the server 202 may be configured to determine the given value 406 of the consistency metric in accordance with Equation (1).

Further, according to some non-limiting embodiments of the present technology, based on the given value 406 of the consistency metric associated with the plurality of assessors 214, the server 202 may be configured to identify, within the plurality of assessors 214, at least one set of assessors for execution at least one subsequent digital task of the plurality of digital tasks 207—such as the set of assessors 414, as described above with reference to FIG. 4.

Thus, in response to the given value 406 of the consistency metric being greater than or equal the predetermined consistency threshold value, the server 202 may be configured to determine the set of assessors 414 as being the plurality of assessors 214, that is, leave the plurality of assessors 214 without changes.

However, in response to the give value 406 of the consistency metric associated with the plurality of assessors 214 being lower than the predetermined threshold value, to determine the set of assessors 414 for executing the at least one subsequent digital task of the plurality of digital tasks 207, the server 202 may be configured to optimize the consistency metric by (1) iteratively identifying and removing those of the plurality of assessors 214 having provided results inconsistent with that provided by the majority—such as the given assessor 216 in the example of FIG. 4; and (2) determining, at each iteration, a respective value of the consistency metric, until it meets the condition of being greater than or equal to the predetermined consistency threshold value. Thus, by excluding from the plurality of assessors 214 those assessors providing inconsistent results, in some non-limiting embodiments of the present technology, the server 202 may be configured to maximize the consistency metric to a value of being greater than or equal to the predetermined consistency threshold value, thereby determining the set of assessors 414 likely to provide consistent results to the at least one subsequent digital tasks of the plurality of digital tasks 207 in future.

Further, in additional non-limiting embodiments of the present technology, where the at least one subsequent digital task is of one of predetermined types of digital tasks, associated with a respective predetermined quality score range of assessors, the server 202 may further be configured to determine the set of assessors 414 such that their respective quality scores are within a predetermined quality range score. To that end, the server 202 may be configured to optimize the consistent metric identifying and removing not only those of the plurality of assessors 214 providing inconsistent results, but also those whose respective quality scores are lower than a lower boundary of the predetermined quality score range, as an example.

In other non-limiting embodiments of the present technology, first, the server 202 may be configured to optimize the consistency metric associated with the plurality of assessors 214 to determine the set of assessors 414, and then identify, within the set of assessors 414, one or more subsets of assessors associated with respective predetermined quality score ranges. For example, as described above with reference to FIG. 5, the server 202 may be configured to identify, in the set of assessors 414, at least two subset of assessors including (1) the first subset of assessors 502, each one of which having a respective quality score within the first predetermined quality score range 512, R^{Q}₁; and (2) the second subset of assessors 504, each one of which having a respective quality score within the second predetermined quality score range 514, R^{Q}₂. In this regard, the server 202 may be configured to submit subsequent digital tasks of the plurality of digital tasks 207 of one predetermined type, associated with the first predetermined quality score range 512, to the first subset of assessors 502; and subsequent digital tasks of an other predetermined type, associated with the second predetermined quality score range 514, to the second subset of assessors 504. Thus, in some non-limiting embodiments of the present technology, the server 202 may be configured to determine a given one of the first subset 502 and the second subset 504 in response to receiving, from the task database 206, subsequent digital tasks of respective predetermined types.

As further noted above with reference to FIG. 5, based on particular values of the first predetermined quality score range 512 and the second predetermined quality score range 514, the first subset of assessors 502 and the second subset of assessors 504 may either be mutually exclusive or at least partially overlap.

Thus, in some non-limiting embodiments of the present technology, for completion of each subsequent digital task of the plurality of digital tasks 207, the server 202 may be configured to determine a respective set of assessors by iteratively applying steps 602 and 604 described above. However, in other non-limiting embodiments of the present technology, the server 202 may be configured to determine new sets of assessors for executing subsequent digital tasks of the plurality of digital tasks 207 from time to time, such as at a predetermined frequency, as an example.

The first method 600 hence advances to step 606.

STEP 606: TRANSMITTING, BY THE PROCESSOR, A SUBSEQUENT DIGITAL TASK TO RESPECTIVE ELECTRONIC DEVICES ASSOCIATED WITH THE AT LEAST ONE SET OF ASSESSORS

Further, at step 606, the server 202 may be configured to transmit indications of subsequent digital tasks of the plurality of digital tasks 207 to respective electronic devices of so identified sets of assessors, thereby submitting the subsequent digital tasks for execution.

The first method 600 thus advances to step 608.

STEP 608: GENERATING THE TRAINING DATA FOR THE COMPUTER-EXECUTABLE MLA INCLUDING DATA GENERATED IN RESPONSE TO RESPECTIVE ONES OF THE AT LEAST ONE SET OF ASSESSORS COMPLETING THE SUBSEQUENT DIGITAL TASK

Finally, at step 608, according to certain non-limiting embodiments of the present technology, the server 202 may be configured to receive the respective pluralities of results responsive to submitting the subsequent digital tasks to the respective sets of assessors—such as the plurality of results 404 provided by the plurality of assessors 214 when completing the given digital task. Further, the server 202 may be configured to aggregate the respective pluralities of results, thereby generating the labelled training data set 218.

The server 202 may further be configured to transmit the labelled training data set 218 to the third-party server 220 for training based thereon the MLA run on the third-party server 220.

Thus, certain non-limiting embodiments of the first method 600 may allow (1) determining sets of assessors for completion of digital tasks providing consistent results thereamong, and (2) thus automatically identifying and banning assessors providing low quality results to digital tasks without having to use control digital tasks, which may further allow generating the training data for training the MLA of higher quality in a more efficient fashion.

The first method 600 thus terminates.

### Determining Quality of Training Data Set

The developers of the present technology have appreciated that the consistency metric described hereinabove with reference to FIG. 4, may be used for determining quality of already generated training data. Thus, in some non-limiting embodiments of the present technology, a respective value of the consistency metric associated with a given training data set may be indicative of a quality thereof. According to certain non-limiting embodiments of the present technology, the given training data set may include at least one plurality of results provided by a respective set of assessors, which has been generated substantially similar to the plurality of results 404 generated in response to submitting the given digital task 208 to the plurality of assessors 214.

Therefore, more specifically, the higher the respective value of the consistency metric determined for the previously generated at least one plurality of results is, the higher the quality thereof is.

Thus, in some non-limiting embodiments of the present technology, the server 202 may be configured to (1) receive an indication of the given training data set including the at least one plurality of results having been generated by the respective set of assessors; (2) based on the at least one plurality of results, determine the respective value of the consistency metric associated therewith, for example, in accordance with equation (1); and (3) in response to the respective value of the consistency metric being greater than or equal to the predetermined consistency threshold value, keep the at least one plurality of results in the given training data set. By contrast, if the respective value of the consistency metric is lower than the predetermined consistency threshold value, the server 202 may be configured to discard the at least one plurality of results from the given training data set.

By so doing, the server 202 may be configured to identify and include, in the given training data set, pluralities of results having higher respective values of the consistency metric, such as those where respective assessors were in accord on the provided results, which may allow for increasing an overall quality of the given training data set.

Below, there are provided certain specific examples of using, by the server 202, the consistency metric for determining the quality of the training data, in accordance with certain non-limiting embodiments of the present technology. It should be noted that the examples below are provided solely for the purposes of illustration and clarity of certain non-limiting embodiments of the present technology, and in no way as a limitation.

### Example 1

Let it be assumed that the server 202 has received (or otherwise generated) the given training data set including the at least one plurality of results presented in the first row of Table 1 below, which has been provided by the respective set of assessors having respective quality scores presented in the second row of Table 1 below.

TABLE 1

| | | | |
|---|---|---|---|
| [symbol] _{w}_{ᵢ} | 1 | 0 | 1 |
| [symbol] _{w}_{ᵢ} | 80 | 85 | 75 |

Thus, based on the at least one plurality of results, in accordance with equation (1), the server 202 may be configured to determine the respective value of the consistency metric as being:

$$Pr ( 1 \vert 1 , 0 , 1 ) = \frac{0.8 \times ( 1 - 0.85 ) / ( 2 - 1 ) \times 0.75}{\begin{matrix}0.8 \times ( 1 - 0.85 ) / ( 2 - 1 ) \times 0.75 + \\ ( 1 - 0.8 ) / ( 2 - 1 ) \times 0.85 ( 1 - 0.75 ) / ( 2 - 1 )\end{matrix}} = 068.$$

As it can be appreciated, notwithstanding a relatively high average value of the respective quality scores of the respective set of assessors, the respective value of the consistency metric may be relatively lower. Thus, given the predetermined consistency threshold value is 0.7, as an example, the server 202 may be configured to discard the at least one plurality of results of the present example from the given training data set.

### Example 2

Now, with reference to Table 2, there is provided another example of the at least one plurality of results where the average value of the respective quality scores of the respective set of assessors is lower than that in Example 1; however, consistency of the result is higher.

TABLE 2

| | | | |
|---|---|---|---|
| [symbol] _{w}_{ᵢ} | 1 | 1 | 1 |
| [symbol] _{w}_{ᵢ} | 65 | 60 | 55 |

Based on the at least one plurality of results and the respective quality scores of the respective set of assessors provided in Table 2, the server 202 may be configured to determine the respective value of the consistency metric as being:

$$Pr ( 1 \vert 1 , 1 , 1 ) = \frac{0.65` \times 0.6 \times 0.55}{\begin{matrix}0.65 \times 0.6 \times 0.65 + ( 1 - 0.65 ) / ( 2 - 1 ) \times \\ ( 1 - 0.6 ) / ( 2 - 1 ) \times ( 1 - 0.55 ) / ( 2 - 1 )\end{matrix}} = 0.97 .$$

Thus, as it can be appreciated, even though the average value of the respective quality scores of the respective set of assessors is relatively low, the respective value of the consistency metric is greater than the predetermined consistency threshold value; hence, the server 202 may be configured to keep the at least one plurality of results of Table 2 in the given training data set.

### Second Method

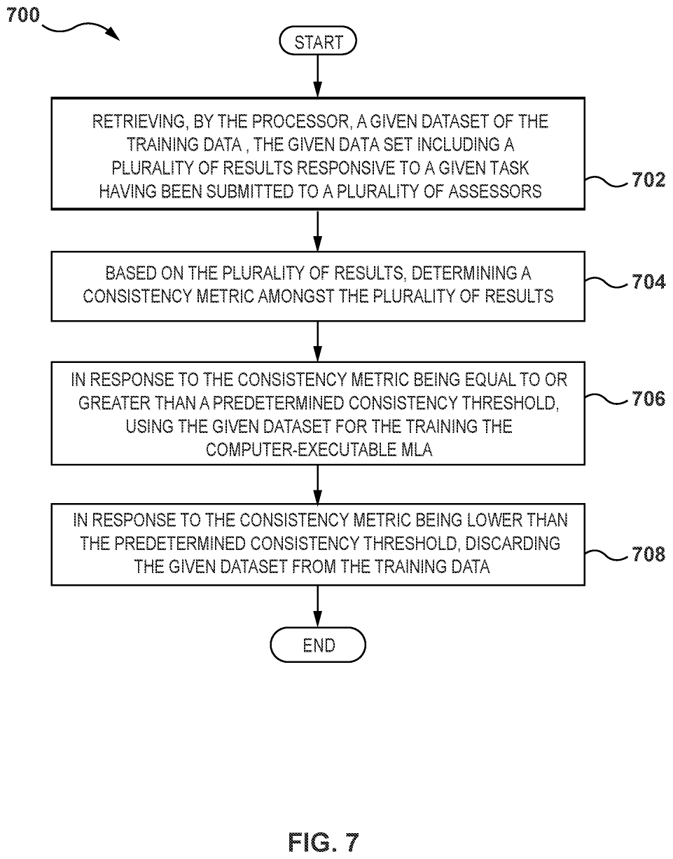

Given the architecture and the examples provided hereinabove, it is possible to execute a method for determining quality of training data for training an MLA having been generated based on digital tasks executed by assessors—such as the plurality of results 404. With reference to FIG. 7, there is depicted a flowchart of a second method 700, according to the non-limiting embodiments of the present technology. The second method 700 can be executed by the server 202 including the computer system 100.

STEP 702: RETRIEVING, BY THE PROCESSOR, A GIVEN DATASET OF THE TRAINING DATA, THE GIVEN DATASET

The second method 700 commences at step 702 with the server 202 being configured to receive (or generate, for example) the given training set of data including the at least one plurality of results having been generated by the respective set of assessors substantially similar to the plurality of results 404 provided by the plurality of assessors 214, as described above with reference to FIG. 4.

In some non-limiting embodiments of the present technology, the given training data set may also include data indicative of respective quality scores of each one of the respective set of assessors having provided the at least one plurality of results.

The second method 700 thus proceeds to step 704.

STEP 704: BASED ON THE PLURALITY OF RESULTS, DETERMINING A CONSISTENCY METRIC AMONGST THE PLURALITY OF RESULTS

Further, at step 704, the server 202 may be configured to determine quality of the at least one plurality of results provided by the respective set of assessors. To that end, based on the at least one plurality of results and respective quality scores of the respective set of assessors, the server 202 may be configured to determine the respective value of the consistency metric associated with the at least one plurality of results.

In some non-limiting embodiments of the present technology, the server 202 may be configured to determine the respective value of the consistency metric in accordance with Equation (1), as described above. In this regard, the consistency metric can be indicative of a number of the respective set of assessors having provided a same result when executing an associated digital task. More specifically, as described above, the higher the respective value of the consistency metric determined for the generated at least one plurality of results is, the higher the quality thereof is.

The second method 700 hence advances to step 706.

STEP 706: IN RESPONSE TO THE CONSISTENCY METRIC BEING EQUAL TO OR GREATER THAN A PREDETERMINED CONSISTENCY THRESHOLD, USING THE GIVEN DATASET FOR THE TRAINING THE COMPUTER-EXECUTABLE MLA

Thus, as explained by Example 2 given above, in response to the respective value of the consistency metric associated with the at least one plurality of results being greater than or equal to the predetermined consistency threshold value, the server 202 may be configured to keep the at least one plurality of results in the given training data set for further use for purposes of training an MLA—such as the MLA run on the third-party server 220.

The second method 700 thus proceeds to step 708.

STEP 708: IN RESPONSE TO THE CONSISTENCY METRIC BEING LOWER THAN THE PREDETERMINED CONSISTENCY THRESHOLD, DISCARDING THE GIVEN DATASET FROM THE TRAINING DATA

Finally, as illustrated above by Example 1, if the respective value of the consistency metric associated with the at least one plurality of results is lower than the predetermined threshold value, the server 202 may be configured to discard the at least one plurality of results from the given training data set.

Thus, certain non-limiting embodiments of the second method 700 may allow increasing overall quality of already a generated training data set based on consistency of provided results to respective digital tasks by associated sets of assessors

The second method 700 thus terminates.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method of generating training data for a computer-executable Machine-Learning Algorithm (MLA), the training data being based on digital tasks accessible by a plurality of assessors; the method being executable at a server including a processor communicatively couplable, over a communication network, to electronic devices associated with the plurality of assessors, the method comprising:
retrieving, by the processor, assessor data associated with the plurality of assessors, the assessor data including data indicative of past performance of respective ones of the plurality of assessors completing a given digital task including data indicative of a plurality of results responsive to the given digital task having been submitted to the plurality of assessors;
based on the plurality of results, determining at least one set of assessors in the plurality of assessors, such that a consistency metric amongst results provided by the at least one set of assessors for the given digital task is maximized,
the consistency metric being indicative of a posteriori probability that a result provided by a majority of the plurality of assessors is a correct result to the given digital task;
transmitting, by the processor, a subsequent digital task to respective electronic devices associated with the at least one set of assessors; and
generating the training data for the computer-executable MLA including data generated in response to respective ones of the at least one set of assessors completing the subsequent digital task.

2. The method of claim 1, wherein the consistency metric is determined in accordance with an equation:
$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$
where z^{MV} is a result of the plurality of result provided by the majority of the plurality assessors,
y_{wi} is a given one of the plurality of results provided by a respective one of the plurality of assessors,
$${q}_{wi} = \frac{{s}_{wi}}{100} ,$$
is a weighted respective quality score of the respective one of the plurality of assessors, and
δ is a binary function returning 1 if an argument thereof is true, else returning 0.

3. The method of claim 1, wherein a given one of the plurality of assessors has a predetermined quality score, and the determining the at least one set of assessors is executed such that a given one of the at least one set of assessors has a respective predetermined quality score within a predetermined quality score range.

4. The method of claim 3, wherein the determining the at least one set of assessors is executed for a type of the subsequent digital task, the type being one of a set of pre-determined types.

5. The method of claim 4, wherein the type of the subsequent task is associated with the predetermined quality score range.

6. The method of claim 3, wherein the respective predetermined quality score has been determined based on accuracy of the given one of the at least one set of assessors completing a control digital task.

7. The method of claim 1, wherein the determining the at least one set of assessors in the plurality of assessors is triggered by receipt, by the server, of the subsequent digital task.

8. The method of claim 1, further comprising determining, at least other one set of assessors for transmitting, to respective electronic devices thereof, an other subsequent task, different form the subsequent task.

9. The method of claim 8, wherein the at least one set of assessors and the at least other one set of assessors at least partially overlap.

10. The method of claim 9, wherein the at least one set of assessors and the at least other one set of assessors are mutually exclusive.

11. A computer-executable method for determining quality of training data having been generated for training a computer-executable Machine-Learning Algorithm (MLA), the training data being based on digital tasks accessible by a plurality of assessors; the method being executable at a server including a processor, the method comprising:
retrieving, by the processor, a given dataset of the training data, the given dataset including:
a plurality of results responsive to a given digital task having been submitted to the plurality of assessors;
based on the plurality of results, determining a consistency metric amongst the plurality of results,
the consistency metric being indicative of a number of the plurality of assessors providing a same result for the given digital task;
in response to the consistency metric being equal to or greater than a predetermined consistency threshold, using the given dataset for the training the computer-executable MLA; and
in response to the consistency metric being lower than the predetermined consistency threshold, discarding the given dataset from the training data.

12. The method of claim 11, wherein the consistency metric is determined in accordance with an equation:
$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$
where z^{MV} is a result of the plurality of result provided by a majority of the plurality of assessors,
y_{wi} is a given one of the plurality of results provided by a respective one of the plurality of assessors,
$${q}_{wi} = \frac{{s}_{wi}}{100} ,$$
is a weighted respective quality score of the respective one of the plurality of assessors, and
δ is a binary function returning 1 if an argument thereof is true, else returning 0.

13. A system for generating training data for a computer-executable Machine-Learning Algorithm (MLA), the training data being based on digital tasks accessible by a plurality of assessors, the system including a server further including:
a processor communicatively couplable, over a communication network, to electronic devices associated with the plurality of assessors,
a non-transitory computer-readable medium storing instructions,
the processor, upon executing the instructions, being configured to:
retrieve assessor data associated with the plurality of assessors, the assessor data including data indicative of past performance of respective ones of the plurality of assessors completing a given digital task including data indicative of a plurality of results responsive to the given digital task having been submitted to the plurality of assessors;
based on the plurality of results, determine at least one set of assessors in the plurality of assessors, such that a consistency metric amongst results provided by the at least one set of assessors for the given digital task is maximized,
the consistency metric being indicative of a posteriori probability that a result provided by a majority of the plurality of assessors is a correct result to the given digital task;
transmit a subsequent digital task to respective electronic devices associated with the at least one set of assessors; and
generate the training data for the computer-executable MLA including data generated in response to respective ones of the at least one set of assessors completing the subsequent digital task.

14. The system of claim 13, wherein the processor is configured to determine the consistency metric in accordance with an equation:
$$Pr ( {z}^{MV} \vert {y}_{{w}_{1}} , … , {y}_{{w}_{n}} ) = \frac{{\prod }_{i = 1 , … , n} {{q}_{{w}_{i}}^{δ ( {z}^{MV} - {y}_{{w}_{i}} )} ( ( 1 - {q}_{{w}_{i}} ) / ( K - 1 ) )}^{δ ( {z}^{{MV}_{\neq {y}_{{w}_{i}}}} )}}{{\sum }_{z = 1 , … , K} {\prod }_{i = 1 , … , n} {{q}_{{w}_{i}}^{δ ( z = {y}_{{w}_{i}} )} ( ( 1 - {q}_{{w}_{i}} ) / ( K - 1 ) )}^{δ ( z \neq {y}_{{w}_{i}} )}} ,$$
where z^{MV} is a result of the plurality of result provided by the majority of the plurality of assessors,
y_{wi} is a given one of the plurality of results provided by a respective one of the plurality of assessors,
$${q}_{wi} = \frac{{s}_{wi}}{100} ,$$
is a weighted respective quality score of the respective one of the plurality of assessors, and
δ is a binary function returning 1 if an argument thereof is true, else returning 0.

15. The system of claim 13, wherein a given one of the plurality of assessors has a predetermined quality score, and the processor is configured to determine the at least one set of assessors such that a given one of the at least one set of assessors has a respective predetermined quality score within a predetermined quality score range.

16. The system of claim 15, wherein the processor is configured to determine the at least one set of assessors for a type of the subsequent digital task, the type being one of a set of pre-determined types.

17. The system of claim 16, wherein the type of the subsequent task is associated with the predetermined quality score range.

18. The system of claim 15, wherein the processor has been configured to determine the respective predetermined quality score based on accuracy of the given one of the at least one set of assessors completing a control digital task.

19. The system of claim 13, wherein the processor is configured to determine the at least one set of assessors in the plurality of assessors responsive to receiving of the subsequent digital task.

20. The system of claim 13, wherein the processor is further configured to determine, at least other one set of assessors for transmitting, to respective electronic devices thereof, an other subsequent task, different form the subsequent task,
the at least one set of assessors and the at least other one set of assessors at least partially overlapping.
